(19) United States
(12) Patent Application Publication
(10) Pub. No.: US 2014/0352225 A1
(43) Pub. Date: Dec. 4, 2014

(54) MOTOR VEHICLE SEAL

(71) Applicant: CQLT Saargummi Technologies S.à.r.l., Remich (LU)

(72) Inventors: Christian Kast, Merzig-Brotdorf (DE); Frank Michaely, Wadern-Nunkirchen (DE)

(73) Assignee: CQLT Saargummi Technologies S.à.r.l., Remich (LU)

(21) Appl. No.: 14/371,116

(22) PCT Filed: Jan. 11, 2013
(86) PCT No.: PCT/DE2013/100007

§ 371 Date: Jul. 8, 2014

(30) Foreign Application Priority Data
Jan. 13, 2012 (DE) 10 2012 100 300.9

(51) Int. Cl. B60J 10/08; E06B 7/23

(52) U.S. Cl. CPC B60J 10/08; E06B 7/2314
USPC 49/475.1

(57) ABSTRACT

The invention relates to a circumferential seal or/and covering on a door or/and opening flap of a vehicle body, comprising a flexible strand (2) having an elastomer material and an adhesive material layer (3) extending in the longitudinal direction of the strand and connecting the strand (2) to the vehicle body (1). According to the invention, the strand (2) can be torn off from the body (1), leaving behind a sufficiently smooth adhesive surface for adhering the body (1) to a replacement part strand.

The invention relates to a circumferential seal or/and covering on a door or opening flap of a vehicle body, having a flexible strand with an elastomer material, and an adhesive material layer extending in the longitudinal direction of the strand and connecting the strand with the vehicle body.

It is known that double-sided adhesive tape is used in the production process for connection of extruded seal strands with vehicle bodies. In other words, the connection is produced by way of two adhesive layers.

A seal of the type stated initially, having a single adhesive layer, is known from WO 02/076 778 A1. A support profile of a multi-part seal strand, which profile can be connected with a seal section of the strand by engaging into it, is continuously fastened onto a seal seat of a car body, with constant feed of adhesive material. In the event of a repair, the seal section of the seal strand held by means of the support profile can easily be removed and replaced with a corresponding replacement part. In the event of damage to the support profile, as well, detaching it from the car body requires great repair effort and expenditure.

The invention is based on the task of creating a new seal of the type stated initially, which can be applied efficiently and is repair-friendly.

The seal or/and covering according to the invention that accomplishes this task is characterized in that the strand can be pulled off from the car body, in whole or in part, leaving an adhesive surface that is sufficiently smooth for adhesion between the car body and a replacement strand.

It is advantageous if, in the event of a repair, an adhesive surface according to the invention that is clean and free of tear-off residue, and can be directly connected with a replacement strand part without complicated re-work, remains when the seal strand, which might have been damaged, is pulled off.

It can be possible to pull the strand off from the complete adhesive material layer, or, together with the adhesive layer, from the car body, leaving such an adhesive surface. For example, in the first case, the adhesive material of the adhesive material layer adheres more strongly, as such, to the paint of the car body than to the elastomer material of the strand; in the second case, vice versa, the adhesive connection between the elastomer material of the strand and the adhesive material layer is stronger than between the adhesive material layer and the car body paint.

Alternatively, the strand can be detached from a part of the adhesive material layer that remains on the car body, together with a part of the adhesive material layer. In this case, the adhesion strength of the adhesive material exceeds the tear strength of the adhesive material layer as such, both on the elastomer material of the strand and on the paint of the car body.

In a further embodiment of the invention, the adhesive material layer is connected with the strand or the car body by way of a parting layer, which facilitates detachment at the layer boundaries in question.

Preferably, the parting layer adheres to the adhesive material layer more strongly than to the strand or the car body. Thus, when the strand is pulled off, either the parting layer with the adhesive material layer remains behind, or the entire seal, including the adhesive material layer and the parting layer, is removed, exposing the car body paint.

Alternatively, the strand, when it is pulled off, can be detachable from the adhesive material layer, together with the parting layer, or from a part of the parting layer that remains on the adhesive material layer, together with a part of the parting layer.

Preferably, the parting layer is pre-fabricated with the strand, particularly co-extruded.

The parting layer can reduce a the adhesion of the adhesive material layer on the elastomer material or car body paint, particularly its wetting by the adhesive material. Alternatively, it is formed from a material, for example foamed elastomer material, the tear strength of which is so low that the parting layer as such tears and forms a planned breaking point.

In particular, the parting layer can have a textile material or perforated film material.

In the event that the parting layer can be detached from the remainder of the strand at weak points, in accordance with a further embodiment, the parting layer can consist of the same elastomer material as the remainder of the strand.

In a further embodiment of the invention, the strand can have a recess that accommodates the adhesive material layer or/and parting layer, at least in part, which recess is open toward the car body.

In such an embodiment, in particular, the hardened adhesive material layer or/and parting layer can form an installation seat for the strand to be installed as a replacement part, which seat significantly facilitates precisely fitted placement of the replacement strand part.

In a further embodiment of the invention, the strand has one or more recesses for accommodation of excess adhesive material. In this connection, these can particularly be longitudinal or transverse grooves. The recess for accommodation of excess adhesive material can also be formed by means of a widened region of the recess mentioned above.

It is practical if a paste-type adhesive is provided to form the adhesive material layer, which adhesive is able to even out any uneven areas present in the seal seat, such as depressions at weld points or steps at overlap points of the car body sheet metal.

Above all, reactive hot-melt adhesives are possibilities for paste-type adhesives.

Alternatively, the adhesive material could also be formed by means of a thermoplastic film that only becomes adhesive when heated.

In a particularly preferred embodiment, this thermoplastic film material is configured in multiple plies, with plies that can be separated from one another when the strand is pulled off. The thermoplastic film material can also be pre-fabricated with the strand, particularly co-extruded.

The invention will be explained in further detail below, using exemplary embodiments and the attached drawings, which relate to these exemplary embodiments. These show:

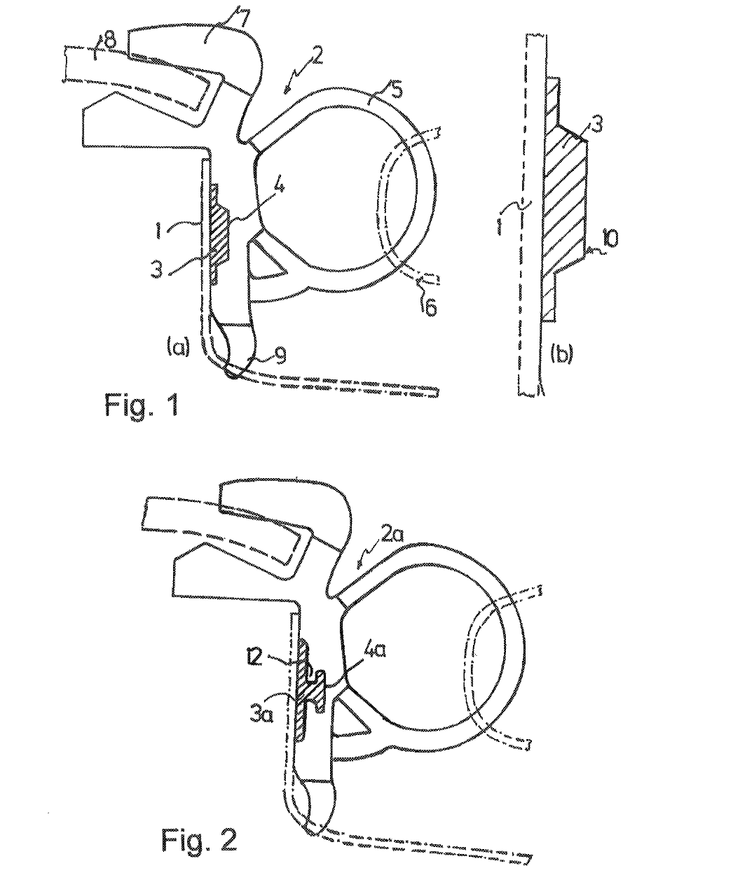

FIGS. 1 and 2 cross-sectional representations of exemplary embodiments of seals according to the invention, with an adhesive material layer that forms an installation seat for accommodation of a replacement strand part;

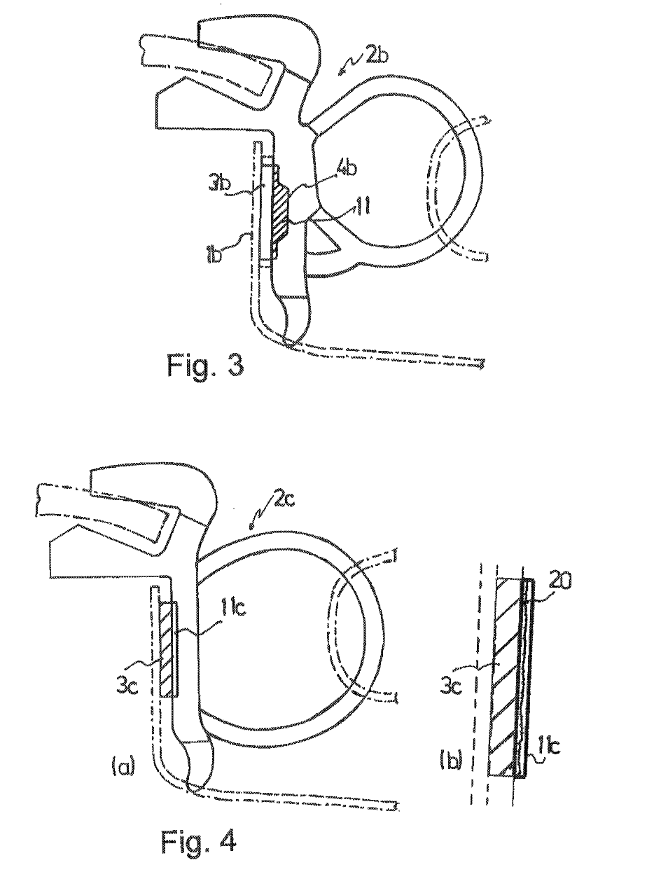

FIGS. 3 and 4 exemplary embodiments of seals according to the invention, with a parting layer between a strand and an adhesive material layer, in cross-section;

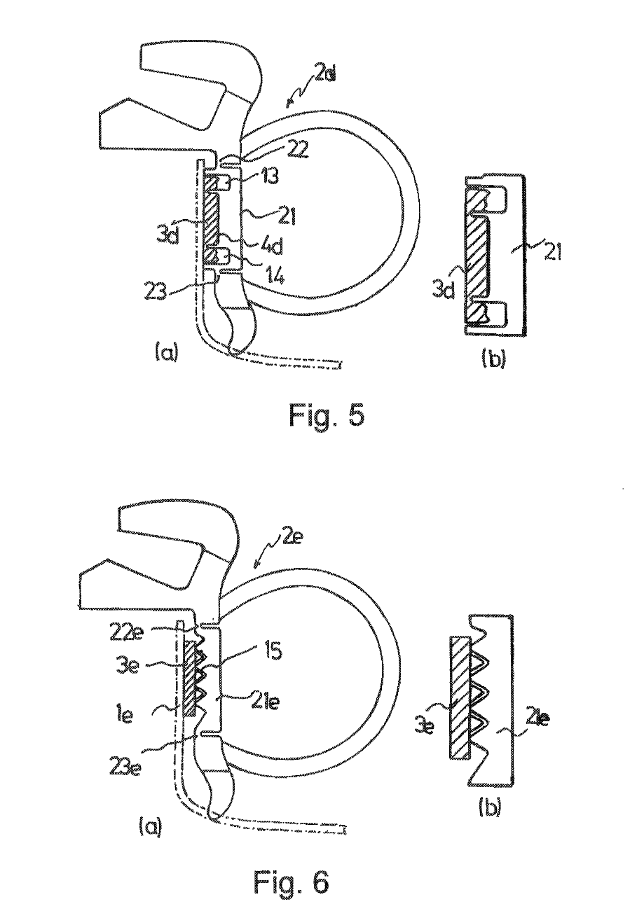

FIGS. 5 and 6 exemplary embodiments of seals according to the invention, with accommodation regions for excess adhesive material, and with weak points, in cross-section; and

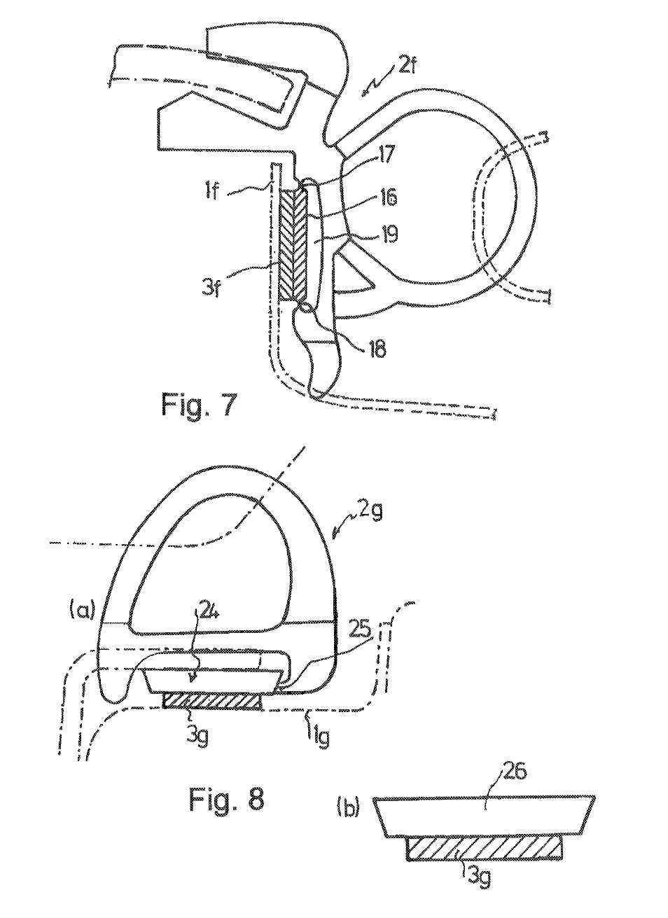

FIGS. 7 and 8 cross-sectional representations of exemplary embodiments of seals according to the invention, with parting layers that can be detached from a strand at weak points.

A seal on a vehicle door, shown in FIG. 1, is connected with a car body flange 1 that runs circumferentially on a door opening edge. The door seal comprises an extruded strand 2 composed of elastomer material, and an adhesive material layer 3 that directly connects the strand 2 with the flange 1. The adhesive material layer 3 is situated within a recess 4 that is provided in the strand 2 and open toward the flange 1. When the vehicle door is closed, a tubular seal section 5 of the strand 2 lies against a further seal indicated at 6, which runs circumferentially around the edge of the vehicle door. The strand 2 furthermore comprises a U-shaped section 7, into which a vehicle interior liner 8 engages with its edge. A sealing tongue 9 of the strand 9 lies against the vehicle body, adjacent to the flange 1.

In the exemplary embodiment shown, the strand 2 was rolled onto the car body flange 1 continuously as an endless strand, and cut off in accordance with the circumferential length of the seal, whereby before the adhesive connection with the flange 1 was made, adhesive material that forms the adhesive material layer 3 was continuously passed to the supplied strand, filling the recess 4. Alternatively, the adhesive material could already be applied during production of the strand, and the filled recess 4 could be covered by a film strip to be removed before the strand is rolled onto the flange. The second alternative is particularly considered if hardening of the adhesive material is initiated only after application of the strand onto the flange, for example by means of supplying heat.

The adhesive material used for the adhesive material layer 3 adheres more strongly to the paint of the car body than to the elastomer material of the strand 2. The strand 2 can therefore be easily replaced with a replacement strand part in the event that a repair becomes necessary, for example, in that a clean installation seat 10 for the replacement strand part, free of torn-off elastomer material remains when the strand 2 is pulled off from the hardened adhesive material layer 3 (FIG. 1b). The installation seat 10 formed by the hardened adhesive material of the adhesive material layer 3, which seat engages into a recess in the replacement strand part that corresponds to the recess 4, significantly facilitates precisely positioned affixation of the replacement strand part on the vehicle. The clean, residue-free surface of the installation seat makes an adhesive connection with the replacement seal part possible, without any complicated re-work.

In the subsequent figures, parts that are the same or have the same effect are referred to with the same reference number as in FIG. 1, with the letter a, b, etc. being added to the reference number in question.

As FIG. 2 shows, an installation seat formed by means of a hardened adhesive material layer 3a could have undercuts 12, so that a replacement strand part with a recess that corresponds to the recess 4a of the strand 2a shown, accommodating the adhesive material layer 3a, could engage at the installation seat. Such an installation seat could also be formed by means of a parting layer according to FIG. 4.

An exemplary embodiment of a door seal shown in FIG. 3 comprises an adhesive material layer 3b, which, in contrast to the exemplary embodiments of FIGS. 1 and 2, is situated outside of a recess 4b formed in the strand 2b. The recess 4b itself is filled with a parting layer 11.

The adhesion of the strand 2b to the parting layer 11 is weaker than the adhesion of the parting layer 11 to the adhesive material layer 3b, and also weaker than the adhesion of the adhesive material layer 3b to the car body flange 1b. The strand 2b can therefore easily be pulled off from the parting layer 11 in the event of a repair, and, as in the case of the exemplary embodiments of FIGS. 1 and 3, an installation seat with a clean surface, directly suitable for an adhesive connection with a replacement strand part, is formed.

It is practical if the parting layer 11 is co-extruded with the strand 2b during production of the strand 2b.

According to FIG. 4, a thinner parting layer 11c as compared with the parting layer 11 is formed, which adheres more strongly to the elastomer material of a strand 2c than the parting layer 11 does to the strand 2b. The parting layer 11c demonstrates a low tear strength, so that it tears within itself when the strand 2c is pulled off, thereby forming a breaking surface 20 that is sufficiently smooth for an adhesive connection with a replacement strand part (FIG. 4b). The parting layer 11c co-extruded with the strand 2c consists of a foamed elastomer material, for example sponge rubber, in the exemplary embodiment shown.

In an exemplary embodiment of a door seal shown in FIG. 5, a strand 2d has a recess 4d for accommodation of an adhesive material layer 3d. Regions 13 and 14 for accommodation of excess adhesive material are provided in the recess 4d. It is advantageous that such regions can even out variations in the feed amount of the adhesive material, particularly during application of the strand 2d as an endless strand. A section 21 of the strand 2d that has the recess 4d with the regions 13, 14 is connected with the remainder of the strand by way of weak points 22 and 23.

When the strand is pulled off, the strand tears at the weak points, and an installation seat 10d formed by the hardened adhesive material layer 3d and the section 21 remains (FIG. 5b).

In an exemplary embodiment shown in FIG. 6, a strand 2e has multiple accommodation grooves 15 in an adhesive surface facing the flange 1e, for excess adhesive material of an adhesive material layer 3e formed between the adhesive surface and the strand 2e. A section 21e of the strand 2e that has the accommodation grooves 15 is connected with the remainder of the strand by way of weak points 22e and 23e. When the strand is pulled off, an installation seat formed by the adhesive layer 3e and the section 21e remains.

An exemplary embodiment of a further door seal shown in FIG. 7 comprises an adhesive material layer 3f that connects a section 16 of a strand 2f with a car body flange 1f. The section 16 is separated from the remainder of the strand 2f by means of a cavity 19, and is connected with the remainder of the strand 2f only by way of weak points 17 and 18.

In the event of a repair, the strand 2f can easily be pulled off, destroying the weak points 17, 18, thereby causing an installation seat for a replacement strand part formed by the section 16 and the adhesive material layer 3e to remain. The replacement strand part can have a recess corresponding to the installation seat.

FIG. 8 shows a seal with a strand 2g that is glued to a vehicle door 1g at a lip 24, by way of an adhesive material layer 3g. The lip 24 has a planned breaking point at 25.

When the strand 2g is pulled off, the strand tears at the planned breaking point 25. An installation seat formed by the adhesive material layer 3d and a separated section 26 of the strand 2g remains.

1. Circumferential seal or/and covering on a door or opening flap of a vehicle body (1), with a flexible strand (2) having an elastomer material, and an adhesive material layer (3) extending in the longitudinal direction of the strand and connecting the strand (2) with the vehicle body (1),
wherein
the strand (2) can be pulled off from the car body (1), in whole or in part, leaving an adhesive surface that is sufficiently smooth for adhesion between the car body (1) and a replacement strand part.

2. Seal or/and covering according to claim 1,
wherein
the strand (2) can be pulled off from the complete adhesive material layer (3) or, together with the complete adhesive material layer (3), from the car body (1), or, together with a part of the adhesive material layer, from a part of the adhesive material layer that remains on the car body.

3. Seal or/and covering according to claim 1, wherein
the adhesive material of the adhesive material layer (3) adheres more strongly to the elastomer material of the strand (2) than to the paint of the car body, or, vice versa, the adhesive material adheres more strongly to the paint of the car body (1) than to the elastomer material of the strand (2).

4. Seal or/and covering according to claim 1, wherein
the adhesive material layer (3) is connected with the strand (2) or the car body by way of a parting layer (11; 16; 21; 24).

5. Seal or/and covering according to claim 4,
wherein
the parting layer (11; 16; 21; 24) is pre-fabricated with the strand (2), particularly co-extruded.

6. Seal or/and covering according to claim 4, wherein
the strand (2) can be pulled off, together with the parting layer (11), from the adhesive material layer, together with a part of the parting layer (11c), from a part of the parting layer (11c) that remains on the adhesive material layer (3c), or from the entire parting layer (11; 16; 21; 24) that remains on the adhesive material layer (3).

7. Seal or/and covering according to claim 4, wherein
the parting layer reduces the adhesion of the strand (2) or of the car body (1) to the adhesive material layer or/and is formed from a material having a lower tear strength, by means of which a planned breaking point is formed.

8. Seal or/and covering according to claim 4, wherein
the parting layer (11) reduces the degree of wetting of the strand (2) or of the car body (1) by the adhesive material of the adhesive material layer.

9. Seal or/and covering according to claim 4, wherein
the parting layer (16; 21; 24) is connected with the remainder of the strand (2) by way of planned breaking points (17, 18; 22, 23; 25).

10. Seal or/and covering according to claim 1, wherein
the strand (2) has a recess (4) that accommodates the adhesive material layer or/and parting layer (11), at least in part.

11. Seal or/and covering according to claim 10,
wherein
an installation seat (10) for the replacement strand part is formed by means of the hardened adhesive material layer (3) or/and parting layer (11; 16; 21; 24).

12. Seal or/and covering according to claim 1, wherein
the strand (2) has a recess (13, 14; 15), for the accommodation of excess adhesive material.

13. Seal or/and covering according to claim 1, wherein
a paste-type adhesive or a thermoplastic film material is provided to form the adhesive material layer (3).

14. Seal or/and covering according to claim 13,
wherein
the thermoplastic film material is configured in multiple plies, with plies that can be separated from one another when the strand (2) is pulled off.

15. Seal or/and covering according to claim 13, wherein
the thermoplastic film material is pre-fabricated with the strand, particularly co-extruded.
